(19) United States
(12) Patent Application Publication
(10) Pub. No.: US 2026/0002046 A1
(43) Pub. Date: Jan. 1, 2026

(54) WATER BLOWN ENVIRONMENTALLY FRIENDLY HIGH YIELD SPRAY POLYURETHANE FOAM

(71) Applicant: BASF SE, Ludwigshafen am Rhein (DE)

(72) Inventor: Josep-Daniel ESLAVA, Rubi Barcelona (ES)

(73) Assignee: BASF SE, Ludwigshafen am Rhein (DE)

(21) Appl. No.: 19/134,795

(22) PCT Filed: Nov. 28, 2023
(86) PCT No.: PCT/EP2023/083259

§ 371 Date: Jun. 2, 2025

(30) Foreign Application Priority Data
Dec. 2, 2022 (EP) 22211110.6

(51) Int. Cl. C09D 175/12; C08G 18/18; C08G 18/48; C08G 18/50; C08G 18/76; C09D 5/18

(52) U.S. Cl. CPC C09D 175/12; C08G 18/1808; C08G 18/1816; C08G 18/1825; C08G 18/1833; C08G 18/482; C08G 18/4829; C08G 18/4837; C08G 18/5024; C08G 18/7671; C09D 5/18; C08G 2110/0083; C08G 2150/60

(57) ABSTRACT

The present invention relates to a process for the production of a polyurethane foam having a density of 5 to 20 g/dm³. by mixing the following to give a reaction mixture: (a) polyisocyanates comprising PMDI, (b) compounds having at least two hydrogen atoms reactive toward isocyanate groups, comprising (b1) at least one polyether polyol obtained by alcoxylation of two or three functional starter molecule having a hydroxyl value of 210 to 400 mg KOH/g and (b2) at least one polyether polyol obtained by alcoxylation of an aliphatic diamine, (c) catalyst comprising (c1) at least one incorporable amine catalyst and (c2) at least catalyst comprising an urea structure, (d) blowing agent, comprising water, (c) optionally flame retardant and (f) optionally auxiliaries and additional substances, spraying the reaction mixture onto a substrate and allowing said reaction mixture to harden to give the polyurethane foam and wherein the reaction mixture comprises less than 1 part by weight of a phosphorous flame retardant. The resent invention is further directed to Polyurethane foam obtainable according to a process according to the present invention.

The present invention relates to a process for the production of a polyurethane foam having a density of 5 to 20 g/dm³, by mixing the following to give a reaction mixture: (a) polyisocyanates comprising PMDI, (b) compounds having at least two hydrogen atoms reactive toward isocyanate groups, comprising (b1) at least one polyether polyol obtained by alcoxylation of two or three functional starter molecule having a hydroxyl value of 210 to 400 mg KOH/g and (b2) at least one polyether polyol obtained by alcoxylation of an aliphatic diamine, (c) catalyst comprising (c1) at least one incorporable amine catalyst, (d) blowing agent, comprising water, (e) optionally flame retardant and (f) optionally auxiliaries and additional substances, spraying the reaction mixture onto a substrate and allowing said reaction mixture to harden to give the polyurethane foam and wherein the reaction mixture comprises less than 1 part by weight of a phosphorous flame retardant. The resent invention is further directed to Polyurethane foam obtainable according to a process according to the present invention.

Numerous publications in the patent literature and other literature describe the known production of polyurethane foams, in particular of rigid polyurethane foams, via reaction of polyisocyanates with compounds having at least two hydrogen atoms reactive toward isocyanate groups, in particular with polyether polyols from alkylene oxide polymerization or with polyester polyols from the polycondensation of alcohols with dicarboxylic acids, in the presence of polyurethane catalysts, blowing agents and other auxiliaries and additional substances.

Polyurethane spray foams are polyurethane foams applied directly in situ by spraying. This also permits by way of example application to vertical areas, and also overhead application. The main applications of polyurethane spray foams are found in the construction industry, acoustic absorbance or thermal insulation, for example in roof insulation.

Significant requirements placed upon polyurethane spray foams are low thermal conductivity and/or good acoustic absorbance properties, low viscosity for a good flowability and spray ability and on the other hand fast reactivity to prevent dripping, adequate foam adhesion on a very wide variety of substrates, low densities and good mechanical properties. The polyurethane foams are usually produced by what is known as the two-component process in which an isocyanate component comprising isocyanates and a polyol component comprising components reactive toward isocyanate are mixed. The other starting materials here, for example blowing agents and catalysts, are usually added to one of the components.

An additional requirement to spray foams, especially if they are employed in enclosed spaces, for example inside of a building, it the requirement to reduce the emissions of volatile organic compounds. To ensure the fast reaction and to prevent dripping, especially in case that chemical bowing agents like water are used, additional catalysts are required. It is known that amine-based catalysts contribute to the emission of volatile organic compounds. Therefore, these catalysts are substituted by reactive amine based catalysts which comprise reactive groups towards isocyanates and therefore are incorporable into the polyurethane network. The disadvantage of incorporable catalysts is that they are less active and therefore a higher amount of catalyst is needed. Nevertheless, higher amounts of amine-based catalysts result in higher corrosivity of the polyol component.

It is known that the polyurethane foam industry uses chemical and/or physical blowing agents to foam the polymer as it forms. Chemical blowing agents are blowing agents that react with the isocyanate function to form a gas, whereas physical blowing agents have a low boiling point and are therefore converted to the gaseous state by the heat of reaction. The chemical, and also the physical, blowing agents here are usually added to the polyol component.

Physical blowing agents mainly used hitherto have comprised chlorofluorocarbons. Since physical blowing agents reduce the viscosity of the polyol component and of the reaction mixture of polyol- and isocyanate component they are often used to improve sprayabillity of the reaction mixture. However, these have now been banned in many parts of the world because of their action in damaging the ozone layer. Physical blowing agents mainly used nowadays comprise fluorinated hydrocarbons, HFCs, and low-boiling-point hydrocarbons, such as pentanes. The shelf life of the respective component is a criterion here and also flammability of the hydrocarbons. In addition, HFC's are expensive. Therefore, there was a need to replace physical blowing agents at least partly.

Another approach to lower viscosity is the addition of liquid flame retardants as phosphor-based flame retardants like TCPP. The addition of TCPP has the disadvantage that significant amounts of 1,2-dichloropropane is formed. 1,2-Dichloropropane has been classified as carcino-genic VOC. Substitution of TCPP is not easy since many inert substances that lower the viscosity of the reaction mixture slowly migrate out of the foam and result in VOC emissions.

It has been object of the present invention to provide a polyurethane spray foam with a very low density having good mechanical properties, especially dimension stability, and low emissions of volatile organic compounds and especially is free of emissions of 1,2-dichloropropane. It was further object to provide a process for the production of a spray foam wherein the reaction is fast enough to prevent dripping and wherein the polyol component is non corrosive and the polyol component as well as the reaction mixture has a low viscosity.

The object of the present invention has been solved by a polyurethane foam having a density of 5 to 20 g/dm³, obtained by a process comprising mixing the following to give a reaction mixture: (a) polyisocyanates comprising PMDI, (b) compounds having at least two hydrogen atoms reactive toward isocyanate groups, comprising (b1) at least one polyether polyol obtained by alcoxylation of two or three functional starter molecule having a hydroxyl value of 210 to 400 mg KOH/g and (b2) at least one polyether polyol obtained by alcoxylation of an aliphatic diamine, (c) catalyst comprising (c1) at least one incorporable amine catalyst, (d) blowing agent, comprising water, (e) optionally flame retardant and (f) optionally auxiliaries and additional substances, spraying the reaction mixture onto a substrate and allowing said reaction mixture to harden to give the polyurethane foam and wherein the reaction mixture comprises less than 1 part by weight of a phosphorous flame retardant. The resent invention is further directed to a process for the production of a polyurethane foam according to the invention.

The present invention concerns polyurethane spray foams which are applied to the substrate directly in situ by spraying, the substrate being by way of example part of a building, for example a wall or a ceiling.

Polyisocyanate (a) used comprises polymeric diphenylmethane diisocyanate. Diphenylmethane diisocyanate is also termed “MDI” hereinafter. Polymeric MDI is a mixture of MDI comprising two aromatic rings with MDI homologs comprising a larger number of aromatic rings, for example homologs comprising 3, 4 or 5 aromatic rings, i.e. with 3-, 4- or 5-functional isocyanates. Polymeric MDI can be used together with other diisocyanates conventionally used in polyurethane chemistry, for example toluene diisocyanate (TDI) or naphthalene diisocyanate (NDI). The diisocyanates preferably comprise at least 80% by weight of diphenylmethane diisocyanate, particularly preferably at least 90% by weight of diphenylmethane diisocyanate and in particular exclusively diphenylmethane diisocyanate, based in each case on the total weight of the diisocyanates. The viscosity of the polyisocyanates (a) here at 25° C. is preferably 250 mPas to 1000 mPas, more preferably 300 mPas to 800 mPas, particularly preferably 400 mPas to 700 mPas and in particular 450 mPas to 550 mPas.

Compounds (b) used having groups reactive toward isocyanates can comprise all known compounds having at least two hydrogen atoms reactive toward isocyanates, for example those with functionality 2 to 8 and with number-average molar mass 62 to 15 000 g/mol: by way of example, it is possible to use polyether polyols, The molar mass of polyetherols is preferably 200 to 15 000 g/mol. It is also possible to use low-molecular-weight chain extenders and/or crosslinking agents, alongside polyetherols. For the purposes of the present disclosure, the expressions “polyether polyol” and “polyetherol” are equivalent.

Polyetherols are by way of example produced from epoxides, for example propylene oxide and/or ethylene oxide, or from tetrahydrofuran, by using starter compounds having active hydrogen, for example aliphatic alcohols, phenols, amines, carboxylic acids, water or compounds based on natural materials, for example sucrose, sorbitol or mannitol, with use of a catalyst. Mention may be made here of basic catalysts or double-metal cyanide catalysts, as described by way of example in PCT/EP2005/010124, EP 0090444 or WO 05/090440.

Component (b) can moreover comprise chain extenders and/or crosslinking agents, for example in order to modify mechanical properties, e.g. hardness. Chain extenders and/or crosslinking agents used comprise diols and/or triols, and also aminoalcohols having molar masses below 200 g/mol, preferably 60 to 150 g/mol. Examples are two functional alcohols, as monoethylene glycol, diethylene glycol, 1,2-propane diol, 1,3 propane diol, 1,4 butane diol, 1,3 butane diol, 1,5 pentane diol, 1,6-hexane diol, neopentyl glycol, tetraethylene glycol, dipropylene glycol, cyclohexane diol and aliphatic or aromatic amine based chain extenders as aliphatic or aromatic diamines like ethylene diamine, triethylene diamine and/or diethyl toluene diamine (DETDA). It is equally possible to use aliphatic and cycloaliphatic triols such as glycerol, trimethylolpropane and 1,2,4- and 1,3,5-trihydroxycyclohexane.

Insofar as chain extenders, crosslinking agents or mixtures thereof are used for the production of the rigid polyurethane foams, quantities advantageously used of these are 0 to 15% by weight, preferably 0 to 5% by weight, based on the total weight of component (b).

The compounds (b) having at least two hydrogen atoms reactive toward isocyanate groups comprise, in the invention, (b1) at least one polyether polyol obtained by alcoxylation of two or three functional starter molecule, having a hydroxyl value of 210 to 400 mg KOH/g and (b2) at least one polyether polyol obtained by alcoxylation of an aliphatic diamine.

In a preferred embodiment the compounds (b) may further comprise at least one aliphatic or aromatic diamine-based chain extender (b3). Preferably aliphatic or aromatic diamine-based chain extender (b3) is diethyltoluenediamine.

In a preferred embodiment of the invention, the compounds (b) comprise at least one polyether polyol (b4) obtained by alcoxylation of a two or three functional starter molecule having a hydroxyl value of 20 to 50 mg KOH/g and/or at least one polyether polyol obtained by alcoxylation of a two or three functional starter molecule having a hydroxyl value of 100 to less than 210 mg KOH/g (b5).

In a preferred embodiment polyetherpolyol (b1) is a propylene glycol having a hydroxy value of preferably 215 to 350 mg KOH/g and more preferably 220 to 300 mg KOH/g.

In a further preferred embodiment polyol (b2) is obtainable by propoxylation of ethylenediamine having an OH-number of preferably 350 to 550 mg KOH/g and more preferably 420 to 520 mg KOH/g.

In a further preferred embodiment polyol (b4) is obtainable by propoxylation and ethoxylation of a two-functional starter molecule having an OH-number of preferably 20 to 50 mg KOH/g and more preferably 25 to 30 mg KOH/g.

In a further preferred embodiment polyol (b5) is obtainable by a alkoxylation of a two-functional starter molecule with ethylene oxide having an OH-number of preferably 120 to 200 mg KOH/g and more preferably 150 to 200 mg KOH/g.

It is especially preferred when the compounds having at least two hydrogen atoms reactive toward isocyanate groups (b) comprise polyols (b1), (b2), (b3), (b4) and (b5). In a particular preferred embodiment the content of polyol (b1) is 5 to 30% by weight, preferably 10 to 20% by weight, of polyol (b2) is 5 to 30% by weight, preferably 12 to 25% by weight, of polyol b3) is 0.5 to 5% by weight, preferably 1.5 to 2.5% by weight, of polyol (b4) is 30 to 60% by weight, preferably 40 to 55% by weight, and of polyol (b5) is 5 to 30% by weight, preferably 12 to 25% by weight, each based on the total weight of the compounds having at least two hydrogen atoms reactive toward isocyanate groups (b). In an even more preferred embodiment the content of polyols (b1) to (b5) is at least 80% by weight more preferred at least 90% by weight, particularly preferred at least 95% by weight and in particular 100% by weight, based on the total weight of compound (b).

Catalysts (c) greatly accelerate the reaction of the compounds (b) having at least two hydrogen atoms reactive toward isocyanate groups and chemical blowing agents (d) with the polyisocyanates (a). Typical catalysts are strong basic amines. The catalysts (c) preferably comprise incorporable amine catalysts (c1).

Typical catalysts employable for production of polyurethanes include for example amidines, such as 2,3-dimethyl-3,4,5,6-tetrahydropyrimidine, tertiary amines, such as triethylamine, tributylamine, dimethylbenzylamine, N-methyl-, N-ethyl- and N-cyclohexylmorpholine, N,N,N′,N′-tetramethylethylenediamine, N,N,N′,N′-tetramethylbutanediamine, N,N,N′,N′-tetramethylhexanediamine, pentamethyldiethylenetriamine, tetramethyldiaminoethyl ether, bis(dimethylaminopropyl)urea, dimethylpiperazine, 1,2-dimethylimidazole, 1-azabicyclo[3.3.0]octane and preferably 1,4-diazabicyclo[2.2.2]octane, and alkanolamine compounds such as triethanolamine, triisopropanolamine, N-methyl- and N-ethyldiethanolamine and dimethylethanolamine. Also known as polyurethane catalysts are organic metal compounds, preferably organic tin compounds, such as tin(II) salts of organic carboxylic acids, for example tin(II) acetate, tin(II) octoate, tin(II) ethylhexoate and tin(II) laurate, and the dialkyltin(IV) salts of organic carboxylic acids, for example dibutyltin diacetate, dibutyltin dilaurate, dibutyltin maleate and dioctyltin diacetate, and also bismuth carboxylates, such as bismuth(III) neodecanoate, bismuth 2-ethylhexanoate and bismuth octanoate, or mixtures thereof. The organic metal compounds may be used in combination with strongly basic amines. Nevertheless since organic metal catalysts are generally instable in the presence of water, these catalysts are less preferred. The application of amine catalysts without reactive group towards ispcyanates is less preferred since these catalysts tend to increase the emissions of volatile organic compounds.

Incorporable amine catalysts (c1) have at least one, preferably 1 to 8 and particularly preferably 1 to 2 groups reactive toward isocyanates, such as primary amine groups, secondary amine groups, hydroxyl groups, amides or urea groups, preferably primary amine groups, secondary amine groups, hydroxyl groups. Incorporable amine catalysts are mostly used for production of low-emission polyurethanes especially employed in automobile interiors. Such catalysts are known and described for example in EP1888664. These comprise compounds which, in addition to the isocyanate-reactive group(s), preferably comprise one or more tertiary amino groups. At least one of the tertiary amino groups in the incorporable catalysts preferably bears at least two aliphatic hydrocarbon radicals, preferably having 1 to 10 carbon atoms per radical, particularly preferably having 1 to 6 carbon atoms per radical. It is particularly preferable when the tertiary amino groups bear two radicals independently selected from methyl and ethyl radical plus a further organic radical. Examples of incorporable catalysts that may be used are bis(dimethylaminopropyl)urea, bis(N,N-dimethylaminoethoxyethyl)carbamate, dimethylaminopropylurea, N,N,N-trimethyl-N-hydroxyethylbis(aminopropylether), N,N,N-trimethyl-N-hydroxyethylbis(aminoethylether), diethylethanolamine, bis(N,N-dimethyl-3-aminopropyl)amine, dimethylaminopropylamine, 3-dimethylaminopropyl-N,N-dimethylpropane-1,3-diamine, dimethyl-2-(2-aminoethoxyethanol), (1,3-bis(dimethylamino)propan-2-ol), N,N-bis(3-dimethylaminopropyl)-N-isopropanolamine, bis(dimethylaminopropyl)-2-hydroxyethylamine, N,N,N-trimethyl-N-(3-aminopropyl)-bis(aminoethylether), 1,4-diazabicyclo[2.2.2]octane-2-methanol and 3-dimethylaminoisopropyl diisopropanolamine or mixtures thereof.

Preferably, catalysts (c) further comprise amine catalysts comprising a urea structure (c2). Thypical examples for a catalysts comprising an urea structure is 3-(dimethylamino)propylurea and 1,3-bis(3-(dimethylamino)propyl)urea. In a preferred embodiment, the catalyst (c2) comprises a mixture comprising 3-(dimethylamino)propylurea and 1,3-bis(3-(dimethylamino)propyl)urea. In a preferred embodiment, the catalyst (c) comprises 1 to8, more preferred 2 to 6 and especially preferred 3 to 5% by weight of catalyst (c2), based on the total weight of compounds (b) to (f).

In a preferred embodiment of the present invention the catalysts (c) comprise, besides incorporable amine catalysts (c1) and catalysts comprising an urea structure (c2), less than 1% by weight, preferably less than 0.1% by weight of non incorporable amine catalysts, based on the total weight of the compounds having at least two hydrogen atoms reactive toward isocyanate groups (b). Most preferred the catalyst (c) does not comprise any catalyst besides catalysts (c1) and (C2).

In an especially preferred embodiment the content of the catalysts (c), except catalysts comprising an urea structure (c2), is less than 8% by weight, more preferred 3 to 6% by weight and particular preferred 3.5 to less than 5% by weight, based on the total weight of compounds (b) to (f).

At least one blowing agent (d) comprising water is used in the invention. Blowing agents may further comprise additional chemical blowing agents and/or physical blowing agents. These blowing agents are described by way of example in “Polyurethane Handbook”, Carl Hanser Verlag, 2^{nd} edition 1994, chapter 3.4.5. The term chemical blowing agent here means compounds which form gaseous products through reaction with isocyanate. Examples of these blowing agents are water and carboxylic acids. The term physical blowing agents means compounds which have been dissolved or emulsified in the starting materials for the polyurethane production reaction and evaporate under the conditions of formation of polyurethane. These are by way of example hydrocarbons, halogenated hydrocarbons, halogenated hydroolefines and other compounds, examples being perfluorinated alkanes such as perfluorohexane, chlorofluorocarbons, and ethers, esters, ketones, acetals, and/or liquid carbon dioxide.

In a preferred embodiment as blowing agents according to the present invention less than 10% by weight of physical blowing agents, based on the total weight of the blowing agents (d) are employed and especially preferred exclusively water is used as blowing agent (d). The amount of blowing agent is chosen to obtain a density of the spray foam of 5 to 20 g/dm³, preferably 7 to 15 g/dm³ and especially preferred 8 to 12 g/dm³. To obtain these densities preferably 10 to 30% by weight, more preferred 15 to 26% by weight and especially preferred 20 to 25% by weight of blowing agent (d), based on the total the total weight of compounds (b) to (f), is employed.

According to the invention flame retardant may be added. Examples of suitable flame retardants are brominated esters, brominated ethers (Ixol) and brominated alcohols such as dibromoneopentyl alcohol, tribromoneopentyl alcohol and PHT-4-diol, and also chlorinated phosphates such as tris(2-chloroethyl) phosphate, tris(1,3-dichloropropyl) phosphate, tricresyl phosphate, tris(2,3-dibromopropyl) phosphate, tetrakis(2-chloroethyl) ethylenediphosphate, dimethyl methanephosphonate, diethyl diethanolaminomethylphosphonate, and also commercially available halogenated flame-retardant polyols. Other phosphates or phosphonates used can comprise diethyl ethanephosphonate (DEEP), triethyl phosphate (TEP), dimethyl propylphosphonate (DMPP), and diphenyl cresyl phosphate (DPC) as liquid flame retardants.

Materials that can also be used other than the abovementioned flame retardants to provide flame retardancy to the rigid polyurethane foams are inorganic or organic flame retardants such as red phosphorus, preparations comprising red phosphorus, aluminum oxide hydrate, antimony trioxide, arsenic oxide, ammonium polyphosphate and calcium sulfate, expandable graphite and cyanuric acid derivatives, e.g. melamine, and mixtures of at least two flame retardants, e.g. ammonium polyphosphates and melamine, and also optionally maize starch or ammonium polyphosphate, melamine and expandable graphite; aromatic polyesters can optionally also be used for this purpose.

Preferred flame retardants do not include any bromine. Particularly preferred flame retardants consist of atoms selected from the group consisting of carbon, hydrogen, phosphorus, nitrogen, oxygen and chlorine, more especially from the group consisting of carbon, hydrogen, phosphorus and chlorine.

Preferred flame retardants comprise no groups reactive toward isocyanate groups. It is preferable that the flame retardants are liquid at room temperature. Particular preference is given to DEEP, TEP, DMPP and DPC.

Since flame retardants, especially liquid flame retardants tend to cause emissions of volatile organic compounds it is essential that less than 1% by weight, preferably 0 to 0.5% by weight, each based on the total weight of compounds (b) to (f), are used. More preferred the flame retardants (e) are free of tris(2-chloropropyl) phosphate (TCPP) and especially preferred no phosphorous flame retardant is used.

It is also optionally possible to add further auxiliaries and/or additional substances (f) to the reaction mixture for the production of the polyurethane foams of the invention. Mention may be made by way of example of surface-active substances, foam stabilizers, cell regulators, fillers, light stabilizers, dyes, pigments, hydrolysis stabilizers, and substances having fungistatic and bacteriostatic action and antioxidants. Such substances are known and described for example in “Polyurethane Handbook”, Hanser Publishers Munich, 2nd edition 1993, chapter chapters 3.4.4 and 3.4.6 to 3.4.11.

Examples of surface-active substances that can be used are compounds which serve to support homogenization of the starting materials and which optionally are also suitable for regulating the cell structure of the plastics. Mention may be made by way of example of emulsifiers, for example the sodium salts of castor oil sulfates and of fatty acids and salts of fatty acids with amines, for example diethylamine oleate, diethanolamine stearate, diethanolamine ricinoleate, salts of sulfonic acids, for example alkali metal or ammonium salts of dodecylbenzene- or dinaphthyl-methanedisulfonic acid and ricinoleic acid; foam stabilizers, for example siloxane-oxyalkylene copolymers and other organopolysiloxanes, ethoxylated alkylphenols, ethoxylated fatty alcohols, paraffin oils, castor oil esters or ricinoleic esters, turkey red oil and peanut oil, and cell regulators, for example paraffins, fatty alcohols and dimethylpolysiloxanes. Other materials suitable for improving emulsifying action and cell structure and/or foam stabilization are the oligomeric acrylates described above having, as pendant groups, polyoxyalkylene moieties and fluoroalkane moieties. Quantities usually used of the surface-active substances are 0.01 to 10 parts by weight, based on 100 parts by weight of component (b).

Foam stabilizers used can comprise conventional foam stabilizers, for example those based on silicone, examples being siloxane-oxyalkylene copolymers and other organopolysiloxanes and/or ethoxylated alkylphenols and/or ethoxylated fatty alcohols.

Light stabilizers used can comprise light stabilizers known in polyurethane chemistry. These comprise phenolic stabilizers, for example 3,5-di-tert-butyl-4-hydroxytoluenes and/or Irganox products from BASF, phosphites, for example triphenylphosphites and/or tris(nonylphenyl) phosphites, UV absorbers, for example 2-(2-hydroxy-5-methylphenyl)benzotriazoles, 2-(5-chloro-2H-benzotriazol-2-yl)-6-(1,1-dimethylethyl)-4-methylphenol, 2-(2H-benzotriazol-2-yl)-6-dodecyl-4-methylphenol, branched and linear, and 2,2′-(2,5-thiophenediyl)bis[5-tert-butylbenzoxazoles], and also those known as HALS stabilizers (hindered amine light stabilizers), for example bis(1-octyloxy-2,2,6,6-tetramethyl-4-piperidinyl) sebacate, n-butyl-(3,5-di-tert-butyl-4-hydroxybenzyl)bis(1,2,2,6-pentamethyl-4-piperidinyl) malonate and diethyl succinate polymer with 4-hydroxy-2,2,6,6-tetramethyl-1-piperidineethanol.

Examples of antioxidants are phenolic substances, such as 2,6-di-tert-butyl-4-methylphenol, benzenepropanolic acid, 3,5-bis(1,1-dimethylethyl)-4-hydroxy-C7-C9 branched alkyl esters, aminic antioxidants such as N,N′-di-isopropyl-p-phenylenediamine, thiosynergists, such as di-lauryl 5-thiodipropionate, phosphites and phosphonites, such as triphenylphosphites, diphenyl-alkylphosphites, benzofuranones and indolinones, other antioxidants such as O-, N- and S-benzyl compounds, triazine compounds, amides of β-(3,5-di-tert-butyl-4-hydroxyphenyl)propionic acid, esters of substituted and unsubstituted benzoic acids, nickel compounds and esters of β-10-thiodipropionic acid or a mixture of two or more of these antioxidants. Such antioxidants are described, for example, in WO2017125291 and are commercially available for example under the trade names Irganox 1076, Irganox 245, Irganox 2000, Irganox E201 (vitamin E), Irganox 5057 or Irgafos 38.

The term fillers, in particular reinforcing fillers, means the conventional organic and inorganic fillers, reinforcing agents, weighting agents, and agents for improving abrasion behavior in paints, coating compositions, etc., these being known per se. Individual examples that may be mentioned are: inorganic fillers such as silicatic minerals, for example phyllosilicates such as antigorite, serpentine, hornblends, amphiboles, chrysotile and talc, metal oxides, for example kaolin, aluminum oxides, titanium oxides and iron oxides, metal salts, for example chalk, barite, and inorganic pigments, for example cadmium sulfide and zinc sulfide, and also glass, etc. It is preferable to use kaolin (china clay), aluminum silicate and coprecipitates of barium sulfate and aluminum silicate, and also natural and synthetic fibrous minerals, for example wollastonite, and fibers of various lengths made of metal and in particular of glass; these can optionally have been sized. Examples of organic fillers that can be used are: carbon, melamine, colophony, cyclopentadienyl resins and graft polymers, and also cellulose fibers, polyamide fibers, polyacrylonitrile fibers, polyurethane fibers and polyester fibers derived from aromatic and/or aliphatic dicarboxylic esters, and in particular carbon fibers.

The inorganic and organic fillers can be used individually or in the form of mixtures, quantities of these added to the reaction mixture advantageously being 0.5 to 50% by weight, preferably 1 to 40% by weight, based on the weight of components (a) to (f), where however the content of mats, nonwovens and wovens made of natural and synthetic fibers can reach up to 80% by weight, based on the weight of components (a) to (f).

Production of the polyurethane according to the invention generally comprises mixing (a) polyisocyanate, (b) polymeric compounds having isocyanate-reactive groups, (c) catalysts and optionally (d) blowing agents, (e) chain extending and/or crosslinking agents and (f) auxiliaries and/or additives to afford a reaction mixture and reacting the reaction mixture to afford the polyurethane. The expression reaction mixture here means for the purposes of the present invention the mixture of the isocyanates (a) with the compounds (b) reactive toward isocyanate when the action conversions are below 90%, based on the isocyanate groups.

It is preferable here to use the two-component process where all of the starting materials (a) to (f) are present either in the isocyanate component (A) or in the polyol component (B). It is preferable here that all of the substances that can react with isocyanate are added to the polyol component (B), while starting materials not reactive toward isocyanates can be added either to the isocyanate component (A) or to the polyol component (B). It is particularly preferable that additives added to isocyanate component (A) are only those bearing no functional groups that react with the NCO function of the isocyanate, i.e. the only additives used are those that are inert in relation to the isocyanate. Isocyanate component (A) and polyol component (B) are mixed to form the reaction mixture. In a preferred embodiment isocyanate component (A) comprising polyisocyanates (a), and a polyol component (B) comprising compounds (b) having at least two hydrogen atoms reactive toward isocyanate groups, catalyst (c) and blowing agent (d) are produced, and then isocyanate component (A) and polyol component (B), are mixed to give the reaction mixture. Polyol component and isocyanate component are preferably reacted in a weight ratio of 90 to 150 parts by weight of isocyanate component (A) to 100 parts by weight of the polyol component (B) more preferred 100 to 120 parts by weight of isocyanate component (A) to 100 parts by weight of the polyol component (B) and especially preferred 110 to 125 parts by weight of isocyanate component (A) to 100 parts by weight of the polyol component (B).

The components (a) to (c) and optionally (d) to (f) are reacted in amounts such that the equivalence ratio of NCO groups of the polyisocyanates (a) to the sum of the reactive hydrogen atoms of the components (b), (c), (d) and optionally (e) and (f) is preferably 0.2 to 1.5:1, more preferred 0.25 to 0.8 to 1 and especially preferred 0.28 to 0.5:1. A ratio of 1:1 here corresponds to an isocyanate index of 100.

An isocyanate component (A) and a polyol component (B) are storage stable and usually can be stored at room temperature for several months. After storage, it might be necessary to homogenize the components (A) and/or (B). In a preferred embodiment the polyol component (B) has a viscosity at 25° C. of 50 to 800 mPas, more preferred 150 to 600 mPas and especially preferred 210 to 550 mPas.

In a preferred embodiment the reaction is conducted in a way that the string time is 7 to 15 seconds, more preferred 8 to 12 seconds and the tack free time is preferably 10 to 30 seconds, more preferred 11 to 22 seconds and especially preferred 12 to 16 seconds. This allows the spraying on walls and over head without dripping of the reaction mixture. In addition, the polyol component is non corrosive.

The polyurethane foam obtained according to the process of the present invention has a low density and good mechanical properties as well as low emissions of volatile organic compounds and especially is free of emissions of 1,2-dichloropropane. In a preferred embodiment the emissions of volatile organic compounds VOC according to the International Standards ISO 16000-3 -6 -9 -11 and EN 16516 is less than 10 milligrams per cubic meter of air after 3 days of foam production and less than 1 milligram per cubic meter of air after 28 days of foam production The process according to the present invention allows the spraying on various substrates as stone, wood, concrete, or fibers.

Examples are used below to explain the invention.

The following parameters were determined:

### Cream Time

Cream time was determined as the time between the start of mixing and the start of volume expansion of the mixture. Cream time was determined in accordance with Annex E of European standard EN 14315-1.

### String Time

String time, also known as gel time, was determined as the interval between mixing and the juncture at which threads could be drawn from the reaction mixture. Gel time was determined in accordance with Annex E of European Standard EN 14315-1.

### Tack-Free Time

Tack-free time was determined as the interval between mixing and the juncture at which the upper surface of the foam is no longer tacky. Tack-free time was determined in accordance with Annex E of European standard EN 14315-1.

### Overall Free Foam Density

Overall free foam density was determined by using the procedure for determination of core envelope density and taking a foam sample from the middle of the sample with all skins from base to surface. These samples were weighed, and their volume was determined, and these values were then used to calculate the density. Overall free foam envelope density was determined in accordance with Annex C of European standard EN 14315-2.

The following substances were used to produce the examples:
Polyol 1: polyetherol starting from a mixture of sucrose and glycerol as starter molecules and propylene oxide with hydroxy number 490 mg KOH/g
Polyol 2: polyetherol starting from propylene glycol as starter molecule and ethylene oxide and propylene oxide with hydroxy number 30 mg KOH/g
Polyol 3: polyetherol starting from ethylenediamine as starter molecule and propylene oxide with hydroxy number 470 mg KOH/g
Polyol 4: polyetherol starting from diethylene glycol as starter molecule and ethylene oxide with hydroxy number 180 mg KOH/g
Polyol 5: polyetherol starting from propylene glycol as starter molecule and propylene oxide with hydroxy number 250 mg KOH/g
Cat 1: Tris-(dimethylaminopropyl) amine
Cat 2: Pentamethyldiethylene triamine (PMDETA)
Cat 3: Diethyltoluoldiamine (DETDA)
Cat 4: 2-[(2-[2-(Dimethylamino)ethoxy]ethyl)methylamino]ethanol, Jeffcat®ZF-10 from Huntsman
Cat 5: N,N,N′-Trimethylaminoethylethanolamine from BASF
Cat 6: Mixture of 3-(dimethylamino)propylurea and 1,3-Bis[3-(dimethylamino)propyl]urea (Dabco NE 1070 from Evonik
Surfactant 1: silicone surfactant, Tegostab B 8870® from Evonik
Surfactant 2: tall oil
Flame retardant 1 (FR1): tris(2-chloropropyl) phosphate (TCPP)
Flame retardant 2 (FR2): triethyl phosphate

Isocyanate: Lupranat® M20 S (polymeric methylenediphenyl diisocyanate (PMDI) with viscosity about 210 mPa*s at 25° C.

### Production Process

Polyol components (B) and isocyanate components (A) were produced as disclosed in Table 1. All amounts are given in parts by weight, based on the polyol component or the isocyanate component, respectively. The components are thoroughly mixed and then foamed by the process described below. The components were foamed via intensive mixing of the polyol component.

TABLE 1

| | Example | Example | Example | Example | Example | Example |
|---|---|---|---|---|---|---|
| | 1 | 2 | 3 | 4 | 5 | 6 |
| Polyol component | | | | | | |
| Polyol 1 | 10 | 10 | 11.1 | 14 | | |
| Polyol 2 | 37.1 | 36 | 40 | 50.6 | 31.8 | 26.96 |
| Polyol 3 | | | | | 12 | 14 |
| Polyol 4 | | | | | 13 | 13 |
| Polyol 5 | | | | | 10 | 9 |
| FR1 | 29.6 | 29.6 | 20 | | | |
| FR2 | | | 4.5 | | | |
| Propylene Carbonate | | | | 11 | | |
| Cat 1 | 1.8 | | | | 2.45 | |
| Cat 2 | 3 | | | | 2.5 | |
| Cat 3 | | | | | 2.45 | 2.45 |
| Cat 4 | | 2.6 | 2.6 | 2.6 | | 1.99 |
| Cat 5 | | 4 | 4 | 4 | | 2.8 |
| Cat 6 | | | | | | 4 |
| Surfactant 1 | 1 | 1 | 1 | 1 | 1 | 1 |
| Surfactant 2 | 0.5 | 0.8 | 0.8 | 0.8 | 0.8 | 0.8 |
| Water | 17 | 16 | 16 | 16 | 24 | 24 |
| Summ polyol component | 100 | 100 | 100 | 100 | 100 | 100 |
| in parts by weight | | | | | | |
| Isocyanat component | | | | | | |
| Isocyanat | 100 | 100 | 100 | 100 | 100 | 100 |

TABLE 2

| | Example 1 | Example 2 | Example 3 | Example 4 | Example 5 | Example 6 |
|---|---|---|---|---|---|---|
| Viscosity @25 C. of | 1000 | 530 | 411 | 446 | 490 | 291 |
| polyol component [mPa*s] | | | | | | |
| Viscosity @25 C. of | 210 | 210 | 210 | 210 | 210 | 210 |
| isocyanate component [mPa*s] | | | | | | |
| Parts of isocyanate | 110 | 110 | 114 | 114 | 118 | 119 |
| for 100 g of polyol [g] | | | | | | |
| Index | 41.2 | 41.6 | 43.9 | 43.2 | 30.4 | 30.3 |
| Cream time [s] @20° C. | 5 | 6 | 6 | 6 | 5 | 6 |
| String time [s] @20° C. | 10 | 10 | 11 | 11 | 10 | 11 |
| Tack free time [s] @20° C. | 12 | 15 | 15 | 15 | 12 | 15 |
| 1,2-Dichloropropane | NO | NO | YES | YES | YES | YES |
| (1,2-DCP) emissions free | | | | | | |
| VOC emissions lower than | YES | YES | NO | YES | YES | YES |
| LCI (Lowest Concentration | | | | | | |
| of Interest) values | | | | | | |
| No catalyst emissions | NO | YES | YES | YES | NO | YES |
| | PMDETA | | | | PMDETA | |
| | detected | | | | detected | |
| Low viscosity (<550 mPa*s) | NO | YES | YES | YES | YES | YES |
| No dangerous good | YES | NO | NO | NO | YES | YES |
| Low GWP | YES | YES | YES | YES | YES | YES |
| | GWP = 1 | GWP = 1 | GWP = 1 | GWP = 1 | GWP = 1 | GWP = 1 |
| | (water blown) | (water blown) | (water blown) | (water blown) | (water blown) | (water blown) |
| Good processability | YES | YES | YES | NO | YES | YES |
| | | | | Releases | | |
| | | | | slowly CO₂ | | |
| | | | | in the drums | | |
| Density [kg/m³] | 12-16 | 12-16 | 12-16 | 12-16 | 8-10 | 8-10 |

Examples 1 to 4 are comparative examples. The 1,2-Dichloropropane (1,2-DCP) and catalyst emissions have been determined after 28 days according to the International Standard ISO 16000-3 -6 -9 -11 by placing a foam sample of every example in a Volatile Organic Compound (VOC) stainless steel test ventilated chamber drawing samples of air from the test chamber outlet after the specified storage duration and analysing these samples of air using gas chromatography and mass spectroscopy.

LCI values are health-based reference concentrations of volatile organic compounds for inhalation exposure used to assess emissions after 28 days from a single product during a laboratory test chamber procedure. LCI values should be applied in product safety assessment with the ultimate goal to avoid health risks from long-term exposure of the general population. They are usually expressed as μg/m³.

Examples 5 and 6 result in 1,2-DCP free foams with very low densities and low emissions of volatile organic compounds which are below the Lowest Concentration of Interest (LCI). In addition the emissions of the foam according to example 6 has even lower emissions of amine based compounds compared to example 5. The polyol components according to the inventive examples 5 and 6 have a low viscosity, are easy to process and are not classified as dangerous goods.

1. A process for the production of a polyurethane foam, comprising:
mixing components to obtain a reaction mixture;
spraying the reaction mixture onto a substrate; and
allowing the reaction mixture to harden to obtain the polyurethane foam;
wherein:
the components of the reaction mixture comprise:
(a) a polyisocyanate comprising PMDI;
(b) a compound having at least two hydrogen atoms reactive toward isocyanate groups, comprising (b1) at least one polyether polyol obtained by alcoxylation of a two or three functional starter molecules having a hydroxyl value of 210 to 400 mg KOH/g and (b2) at least one polyether polyol obtained by alcoxylation of an aliphatic diamine;
(c) a catalyst comprising (c1) at least one incorporable amine catalyst;
(d) a blowing agent,-comprising water;
(e) optionally a flame retardant; and
(f) optionally auxiliaries and additional substances;
the reaction mixture comprises less than 1 part by weight of a phosphorous flame retardant; and
the polyurethane foam has a density of 5 to 20 g/dm³.

2. The process according to claim 1, comprising:
preparing an isocyanate component (A) comprising the polyisocyanate (a);
preparing a polyol component (B) comprising the compound (b), the catalyst (c), and the blowing agent (d); and
mixing the isocyanate component (A) and the polyol component (B) to obtain the reaction mixture.

3. The process according to claim 1, wherein the catalyst (c) further comprises at least one catalyst comprising a urea structure (c2).

4. The process according to claim 1, wherein a content of the catalyst (c), excluding catalysts comprising a urea structure (c2), is less than 8% by weight, based on a total weight of components (b) to (f).

5. The process according to claim 1, wherein isocyanates and isocyanate reactive compounds are mixed at an isocyanate index of 25 to 80.

6. The process according to claim 1, wherein water is used in an amount of 10 to 30% by weight, based on a total weight of compounds (b) to (f).

7. The process according to claim 1, wherein the compound (b) comprises at least one aliphatic or aromatic diamine-based chain extender (b3).

8. The process according to claim 1, wherein the compound (b) comprises at least one polyether polyol obtained by alcoxylation of a two or three functional starter molecule having a hydroxyl value of 20 to 50 mg KOH/g (b4).

9. The process according to claim 1, wherein the compound (b) comprises at least one polyether polyol obtained by alcoxylation of a two or three functional starter molecule having a hydroxyl value of 100 to less than 210 mg KOH/g (b5).

10. The process according to claim 1, wherein the compound (b) comprises, based on a total weight of the compound (b);
5 to 30% by weight of the polyol (b1),
5 to 30% by weight of the polyol (b2),
0.5 to 5% by weight of at least one aliphatic or aromatic diamine based chain extender (b3),
30 to 60% by weight of at least one polyether polyol obtained by alcoxylation of a two or three functional starter molecule having a hydroxyl value of 20 to 50 mg KOH/g (b4), and
5 to 30% by weight of at least one polyether polyol obtained by alcoxylation of a two or three functional starter molecule having a hydroxyl value of 100 to less than 210 mg KOH/g (b5).

11. The process according to claim 2, wherein the polyol component (B) has a viscosity of 50 to 800 mPa·s.

12. The process according to claim 1, wherein a string time is 7 to 15 seconds and a tack free time is 10 to 30 seconds.

13. A polyurethane foam obtained by the process according to claim 1.

14. The polyurethane foam according to claim 13, wherein emissions of volatile organic compounds total VOC after 28 days according to the International Standard ISO 16000-3 -6 -9 -11 are less than 1 mg/m³.
